(19) United States
(12) Patent Application Publication
(10) Pub. No.: US 2002/0059737 A1
(43) Pub. Date: May 23, 2002

(54) Method and system for restoring articles that have been damaged by moisture

(76) Inventors: Alan R. Anger, Champlin, MN (US); Terance M. Smith, Bellevue, WA (US)

Correspondence Address: Christopher L. Holt, WESTMAN CHAMPLIN & KELLY, International Centre, Suite 1600, 900 South Second Avenue, Minneapolis, MN, 55402-3319, US

(21) Appl. No.: 09/991,816

(22) Filed: Nov. 19, 2001

Related U.S. Application Data
(60) Provisional application No. 60/249,942, filed on Nov. 20, 2000.

(51) Int. Cl. F26B 5/06

(52) U.S. Cl. 34/284

(57) ABSTRACT

The present invention provides a method and system whereby the contents of a structure that have been damaged by moisture can be salvaged and restored conveniently and at a reasonable cost to the owner of the items or the owner's insurance company. The invention provides a bag having an open portion through which an item can be placed within the bag. After an item is placed within the bag, the bag is then closed and sealed shut. Next, a vacuum is created within the bag such that the content item is squeezed. Finally, with the vacuum still maintained within the bag, the bag is transferred to a freeze drying chamber where the bag and its contents are freeze dried.

### CROSS-REFERENCE TO RELATED APPLICATIONS

This application is based on and claims the priority of an earlier filed co-pending U.S. provisional application Serial No. 60/249,942, filed Nov. 20, 2000, entitled “METHOD AND SYSTEM FOR RESTORING ARTICLES THAT HAVE BEEN DAMAGED BY MOISTURE”.

### BACKGROUND OF THE INVENTION

The present invention relates generally to the restoration of damaged goods. More specifically, the invention relates to a method and system for restoring articles that have been damaged by moisture.

Each and every year a significant number of business and home owners are forced to invest a substantial amount of money in the repair of water damage that occurs as the result of an accident or an unexpected disaster such as a fire or flood. An industry has developed around the salvage and restoration of structures that have suffered major water damage. The industry, however, has generally overlooked the salvage and restoration of the specific contents of a structure. In some cases, the salvage and restoration of the structure is inconsistent with the salvage and restoration of the structure's contents. For instance, it is not uncommon for salvage and restoration companies that specialize in restoring water damaged structures to greatly increase the humidity within the structure during the restoration process. This increase in humidity can cause the unremoved contents of a structure to absorb more moisture than would have been absorbed had the structure restoration not been performed. While in some cases, the burden associated with salvaging and restoring the contents of a structure may outweigh the cost of replacing the contents, in other cases, such as when a high sentimental value is given to content items, the burden of salvage and restoration may be the best alternative. In addition, while insurance companies are unlikely to compensate for damage in accordance with an item's attached sentimental value, insurance companies may provide compensation for expenditures related to the salvage and restoration of water damaged items.

Other objects of the invention will become apparent from the detailed description of the invention and the accompanying drawings.

### BRIEF SUMMARY OF THE INVENTION

The present invention provides a method whereby the contents of a structure that have been damaged by moisture can be salvaged and restored conveniently and at a reasonable cost to the owner of the items or the owner's insurance company. The invention provides a bag having an open portion through which an item can be placed within the bag. After an item is placed within the bag, the bag is then closed and sealed shut. Next, a vacuum is created within the bag such that the content item is squeezed. Finally, with the vacuum still maintained within the bag, the bag is transferred to a freeze drying chamber where the bag and its contents are freeze dried.

According to one embodiment of the present invention, the item to be restored is a paper product. Press members are attached to the paper product and a breather material is wrapped around the paper product and the attached press members. Then, the paper product, the attached press members and the wrapped breather material are placed into a bag which is then closed and sealed. Then, a vacuum is created within the bag, and the bag, with its contents still under vacuum pressure, is freeze dried. Finally, the vacuum pressure within the bag is increased so as to eliminate warping of the paper product.

According to another embodiment of the present invention, a system is provided that includes a damaged article, a bag, an air pump, a sealing member and a freeze drying apparatus. The damaged article is placed into the bag which is then closed and sealed shut. The air pump which includes a hose having an end member designed to engage the bag is used to create a vacuum within the bag. The air pump hose is then disengaged from the bag thereby creating an opening in the bag. The sealing member is then used to seal the opening in the bag such that a vacuum is maintained within the bag. Next, the bag and its contents are placed in the freeze drying apparatus where they are freeze dried. Finally, the bag and its contents are removed from the freeze drying apparatus and the breather material and press members are removed from the then restored article.

### BRIEF DESCRIPTION OF THE DRAWINGS

FIG. 1 shows a perspective view of an article within a bag in accordance with an embodiment of the current invention.

FIG. 2A is a side view of a bag and a particular closure device in accordance with an embodiment of the current invention.

FIG. 2B is a side view of a bag and a particular closure device in accordance with an embodiment of the current invention.

FIG. 2C is a end view of a bag opening that includes a particular closure device in accordance with an embodiment of the current invention.

FIG. 2D is a top view of a sealed bag in accordance with an embodiment of the current invention.

FIG. 3A is an end view of a bag which includes an enclosed article and an air pump hose that includes an end member in accordance with an embodiment of the current invention.

FIG. 3B is a top view of a bag with an attached sealing member in accordance with an embodiment of the current invention.

FIG. 4A is an end view of a bag which includes an enclosed article and an air pump hose that includes an end member in accordance with an embodiment of the current invention.

FIG. 4B is a top view of a bag with an attached sealing member in accordance with an embodiment of the current invention.

FIG. 4C is a cross-sectional view of a bag and an attached sealing member in accordance with an embodiment of the current invention.

FIG. 5 is a top view of a bag attached to a pump that has not been activated and a deodorizer compartment in accordance with an embodiment of the current invention.

FIG. 6 is a top view of a bag attached to a pump that has been activated and a deodorizer compartment in accordance with an embodiment of the current invention.

FIG. 7 is a perspective view of a n example of a freeze drying apparatus in accordance with the current invention.

FIG. 8 is a perspective view of a book situated between top and bottom press members in accordance with an embodiment of the current invention.

FIG. 9 is an end view of a book that has been attached to press members in accordance with embodiments of the current invention.

FIG. 10 is a perspective view of a book and attached press boards that have been wrapped in breather material in accordance with an embodiment of the current invention.

For convenience, items in the figures having the same reference symbol are the same or serve the same or similar function.

### DETAILED DESCRIPTION OF THE ILLUSTRATIVE EMBODIMENTS

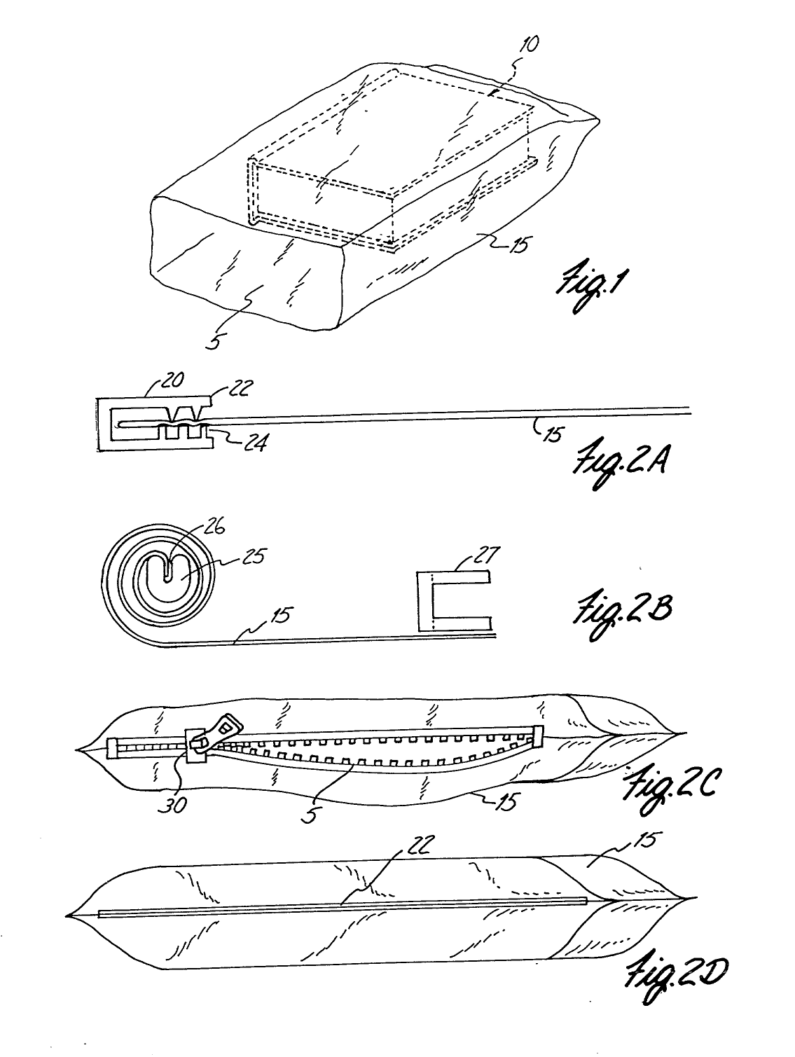

As was discussed above, accidents and unexpected disasters such as fires or floods often leave the contents of a structure with damage caused by moisture. A method and system for restoring articles that have been damaged by moisture is provided by the current invention. In accordance with the invention, an article is first inserted into a bag. FIG. 1 illustrates an article 10 that has been inserted through opening 5 and placed within bag 15. Bag 15 could be made of a number of materials, but is illustratively nylon or plastic. While the article 10 in FIG. 1 is depicted as being a book, it is to be understood that other articles, such as, but not limited to stuffed animals, quilts, clothing, collectibles, paper products, or any other items that have been damaged by moisture could be restored utilizing the method and system of the current invention.

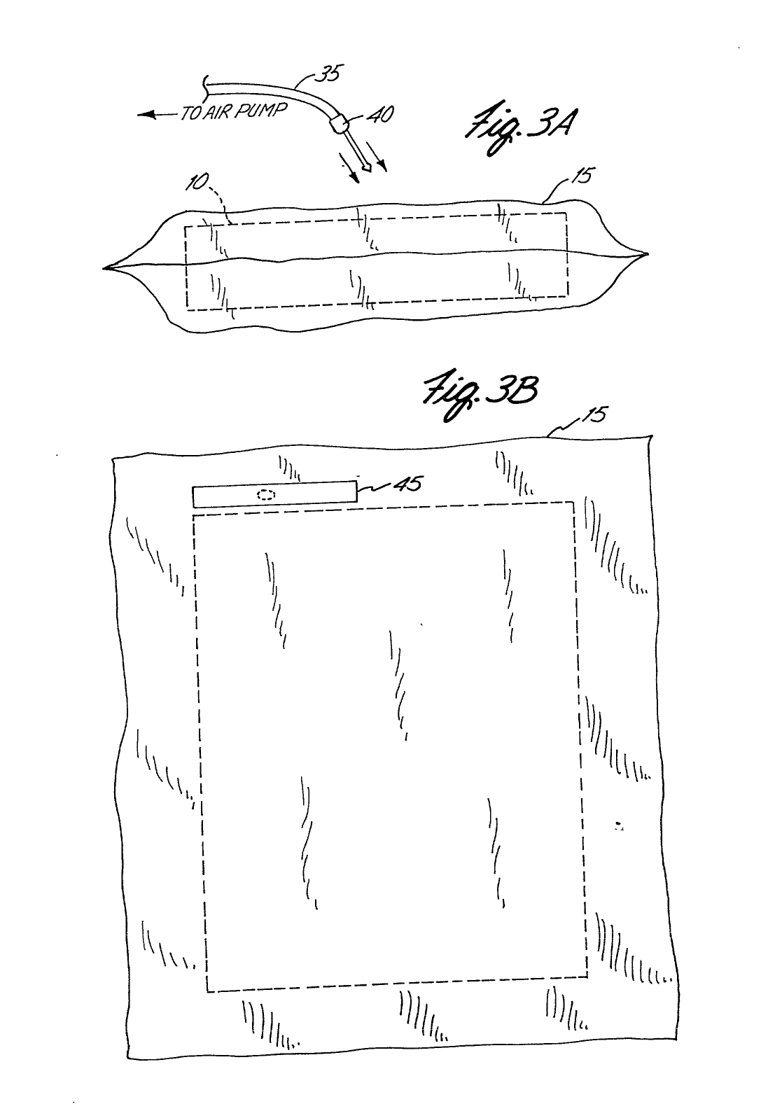

After an article 10 has been inserted into bag 15, the next step, in accordance with the current invention, is to close and seal shut opening 5 through which the article was inserted into bag 15. FIGS. 2A, 2B, 2C and 2D illustrate four different closures for closing and sealing opening 5 of bag 15. Each illustrated closure is a separate embodiment of the current invention and the four embodiments as a whole illustrate only a few of the many potential ways that opening 5 of bag 15 could be closed and sealed. It is to be understood that the current invention is not to be limited to the particular closure devices depicted in FIGS. 2A, 2B, 2C or 2D.

Turning first to FIG. 2A, a corresponding tooth connector 20 is illustrated and is an example of a closure device that could be used to close and seal opening 5 of bag 15. In accordance with the FIG. 2A embodiment, the opening 5 portion of bag 15 is inserted between upper tooth row 22 and lower tooth row 24 and then the tooth rows 22 and 24 are clamped together thereby closing and sealing bag 15.

FIG. 2B illustrates another device that can be used to close and seal bag 15. In the FIG. 2B embodiment, the opening 5 portion of bag 15 is inserted into gap 26 of roll and clamp bar 25. Then, roll and clamp bar 25 is rolled forward thereby gathering the unfilled portions of bag 15. Finally, roll and clamp bar 25, with the gathered unfilled portions of bag 15, is inserted into clamp 27 thereby sealing, closing and securing bag 15.

FIG. 2C illustrates a front view of a bag 15 that includes an opening 5 with a built-in zipper 30 for closing and sealing bag 15.

Finally, FIG. 2D illustrates a top view of a bag 15 that has been closed and sealed shut by means of a plastic heat seal 22. In essence, plastic heat seal 22 is a strip across opening 5 of bag 15 where a top plastic layer of bag 15 has been melted to a lower plastic layer of bag 15. While any number and size of heat seals could be used, several 5 millimeter heat seals or one large 10 millimeter heat seal is preferred for one embodiment.

In addition to, or in place of, the illustrated bag enclosure devices, a zip-lock seal, similar to those commonly associated with plastic bag containers such as sandwich bags, could also be used to close and seal bag 15.

After opening 5 of bag 15 has been closed and sealed, the next step, in accordance with the current invention, is to create a vacuum within bag 15. The creation of a vacuum within bag 15 illustratively pulls water out of the contents of the bag thereby reducing subsequent drying time. The vacuum also prevents molding by removing air, a necessary element for mold, from bag 15. In one illustrative embodiment of the current invention, an air pump including a hose having an end member designed to engage bag 15 is utilized to create a vacuum within bag 15. A single pump could have more than one hose, each with an attached end member, to facilitate the simultaneous restoration of multiple articles.

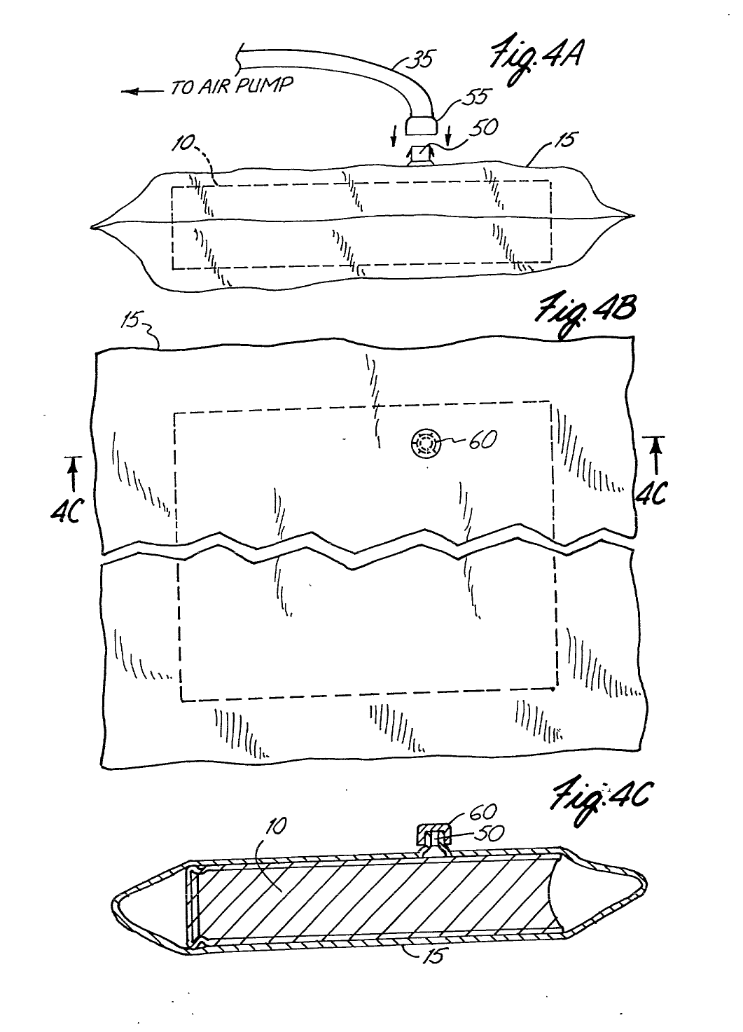

FIG. 3A illustrates an embodiment of the current invention wherein the hose end member is a needle 40 used to puncture bag 15 which allows air to be removed from bag 15 through hose 35 by an air pump. Needle 40 is inserted into bag 15 so as to not cause damage to article 10. After a vacuum has been created within bag 15, needle 40 is removed from bag 15 thereby leaving an opening created by needle 40 in bag 15. In accordance with the current invention, a sealing member is used to seal the opening in bag 15 so that a vacuum is maintained within bag 15. FIG. 3B illustrates an embodiment of the current invention wherein the sealing member is a tape piece 45 which is used to seal an opening in bag 15 thereby maintaining a vacuum within bag 15.

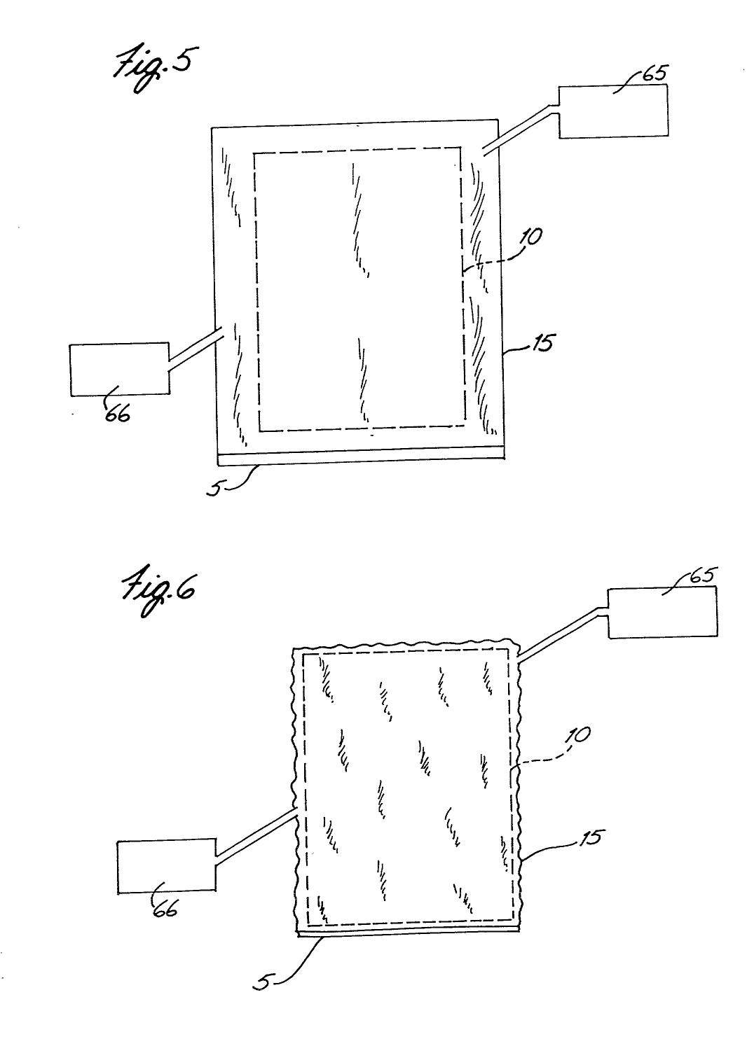

FIG. 4A illustrates another embodiment in accordance with the present invention, wherein bag 15 includes an air valve portion 50. The end member of hose 35 in this embodiment is a connector 55 designed to engage air valve portion 50, thereby enabling the removal of air from bag 15 through hose 35 by means of an air pump connected to hose 35. In one embodiment of the current invention, valve portion 50 is a one-way valve that allows air to exit but not to enter bag 15. After air has been removed from bag 15 and a vacuum has been created within bag 15, connector 55 is disengaged from air valve portion 50 thereby leaving an opening in bag 15. In accordance with this same embodiment, as is illustrated by FIG. 4B, air valve opening cap 60 is utilized as a sealing member to close the opening in bag 15. If air valve portion 50 is a one-way valve as described above, than a sealing member may not be necessary, but a sealing member may still be desirable in such a case to protect and ensure the cleanliness of valve portion 50. FIG. 4C is a side view taken along 4C in FIG. 4B and illustrates air valve opening cap 60 engaged to air valve opening 50 thereby maintaining a vacuum in bag 15 around article 10.

FIG. 5 illustrates another feature of the present invention and is a top view of a bag attached to a pump 65 before pump 65 is activated and a vacuum is created within bag 15. At this point in the process, it is unimportant whether opening 5 of bag 15 has been closed and sealed. In accordance with an embodiment of the current invention, FIG. 5 also shows a deodorizer compartment 66 attached to bag 15. Until a vacuum is drawn by pump 65, deodorizer compartment 66 is not operational. FIG. 6 is a top view of a bag 15 after it has been attached to a pump that has been activated and a vacuum is being created within bag 15. At this point in the process, it is essential that opening 5 be closed and sealed. As air is drawn into pump 65 to create a vacuum within bag 15, deodorizing material, as the result of suction force, is drawn from deodorizer compartment 66 into bag 15. The deodorizing material helps to remove unwanted orders (smoke scent, molding scent, etc.) from an article. Other materials, such as an anti-mold material could also be sent from deodorizer compartment 66 into bag 15. After the vacuum is created within bag 15, the pump 65 and deodorizer compartment 66 are disengaged and all holes in bag 15 that result from disengagement are closed and sealed with a sealing member.

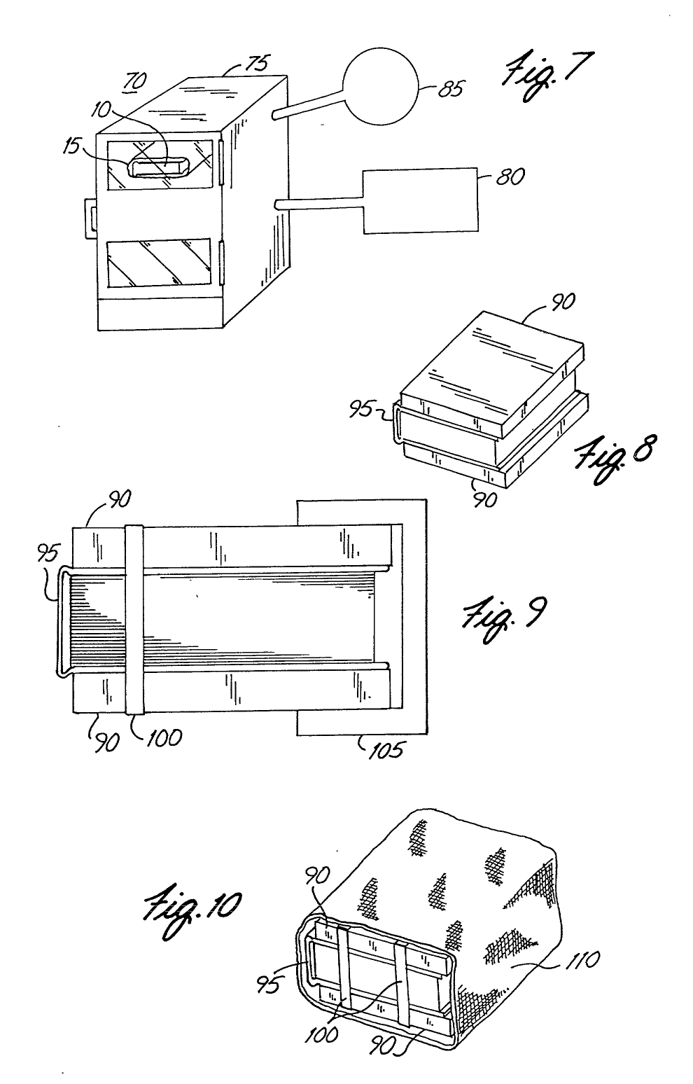

After an article has been sealed and in a vacuum tight bag, in accordance with the current invention, the bag and the enclosed article are then freeze dried. FIG. 7 illustrates a freeze dry apparatus 70 that includes an article chamber 75, a vacuum pump 80 and a condensation chamber 85. During the freeze dry process of the current invention, a vacuum sealed bag 15 with an enclosed article 10 is placed within article chamber 75 of freeze dry apparatus 70. Bag 15 and article 10 are then frozen. It should be noted that in some freeze dry systems, an article is frozen outside of an article chamber and then placed in the article chamber. Such freeze dry systems typically include a freezing apparatus that is independent of the freeze drying apparatus. While one particular freeze dry system is illustrated in FIG. 7, it is to be understood that the system and method of the current invention could incorporate any freeze dry system known in the art. Continuing with the description of the current invention, the frozen bag 15 and enclosed article 10 are subjected to a high vacuum created by air pump 80. Under these conditions, water frozen within article 10 will change states from a solid to a gas (sublimation). The gas will then enter condensation chamber 85 where it is isolated and contained. In this manner, bag 15 and article 10, which are made of a non-sublimable material, are left behind in a dry state.

In accordance with an embodiment of the current invention, the above described process and system can be utilized to restore, flatten and dry paper products. In accordance with this embodiment, several steps relating to the preparation of a paper product to be restored and to the flattening of the paper product are taken in addition to the steps included in the above-described method and system. Accordingly, once a paper product that is to be restored is obtained, non-absorbing rigid press members are inserted above and below the paper product. FIG. 8 illustrates a damaged book 95 with press members 90 inserted above and below the damaged book 95. It should be noted that while the illustrated damaged paper product is a book, the method and system of the current invention could just as easily be applied to other paper products, such as but not limited to magazines, manuscripts, and collections of papers. It should also be noted that when the paper product to be restored is a book, the press members are illustratively not inserted over the spline of the book so as to avoid the crushing of the book spline during the vacuum and flattening stages of the restoration process.

After the press members are inserted above and below the paper product, rubberbands or clamps are optionally used to attach the press members to the damaged paper product. Attaching the press members to the paper product prevents the press members from sliding to an undesirable position such as over the spline of a book. FIG. 9 illustrates damaged book 95 with press members 90 inserted above and below the non-spline portion of a paper product. In FIG. 9, rubberband 100 and clamp 105 have been utilized to attach the press members 90 to the damaged paper product. It is to be understood that press members could be attached using any combination of rubberbands or clamps and could be attached using rubberbands or clamps exclusively. Rubberbands may be preferred over clamps as a cheaper alternative that provides a more even pressing surface that facilitates the stacking of damaged paper products with attached press members. In addition, any other method similar to rubberbands or clamps could be utilized to attach press members to a paper product. Alternatively, press members could be attached to or integrally formed within the walls of a bag.

After the press members have been attached to the damaged paper product, a breather material is wrapped around the damaged paper product and the attached press members. The breather material is illustratively a cloth (such as felt) and helps to enable air to be totally removed when air is being drawn from a bag during a vacuum draw. The breather cloth also prevents a plastic bag from sticking to or tearing a paper product. FIG. 10 illustrates a damaged paper product 95 with press members 90 that have been attached by rubberbands 100 and a breather material 110 wrapped around the damaged paper product 95 and attached press boards 90. After breather material 110 has been wrapped around the items, the damaged paper product 95, attached press members 90 and wrapped breather material 110 are inserted into a bag and the bag and its contents are vacuum squeezed and freeze dried as described above in relation to other above described embodiments of the current invention. In one embodiment of the current invention, the breather cloth is attached to or integrally formed within the walls of a bag. In accordance with this embodiment, press members may or may not also be attached to or integrally formed within the bag.

Once a paper product, the attached press members and wrapped breather material have been freeze dried, the final step is to flatten any warping that may have occurred to the paper product. In order to flatten the paper product, an air pump is once again engaged to bag 15. Additional air is drawn from bag 15 to increase the pressure of the boards on the paper product, thereby encouraging the elimination of any warping. The pump is then disengaged from bag 15 and a sealing member is again used to maintain a vacuum within bag 15. The paper product can stay within vacuum sealed bag 15 for any desired time before being removed. During that time, it is preferable to stack multiple vacuum sealed paper products upon one another to utilize the force of gravity to aid in the elimination of warping damage. After the desired time has passed, the flat, dry paper product is removed from bag 15, the attached press members and the breather material.

While the above invention has been described in the context of the restoration of damaged items, the same inventive concepts could also be applied in different contexts. For instance, documents, books and other articles could be prepared and stored in vacuum tight dry containers for any period of time without risk of molding, water damage, or warping. Accordingly, the protected storage of articles is another context to which the concepts of the current invention could be applied.

Although the present invention has been described with reference to the illustrative embodiments, workers skilled in the art will recognize that changes may be made in form and detail without departing from the spirit and scope of the invention.

What is claimed is:

1. A method of restoring articles that have been damaged by moisture, which comprises:
inserting an article into a bag;
sealing the bag;
creating a vacuum within the bag by removing air from the bag; and
freeze drying the article.

2. The method of claim 1 further comprising the step of sealing all holes in the bag after a vacuum has been created so that the vacuum is maintained.

3. The method of claim 2 further comprising the step of removing the article from the bag after the bag and its contents have been freeze dried.

4. A method of restoring paper products that have been damaged by moisture, which comprises:
attaching press members to a paper product;
wrapping the paper product and the attached press members in a breather material;
placing the paper product, the attached press members and the wrapped breather material into a bag;
sealing the bag;
creating a vacuum within the bag; and
freeze drying the bag and its contents.

5. The method of claim 4 wherein the step of creating a vacuum within the bag comprises the steps of:
connecting an air pump hose to the bag;
using an air pump to remove air out of the bag through the air pump hose, thereby creating the vacuum within the bag; and,
disconnecting the air pump hose from the bag and maintaining a vacuum in the bag by sealing any openings in the bag created by the disconnection of the hose.

6. The method of claim 4 further comprising the step of removing the vacuum sealed bag, the breather material and the press members from the paper product after the bag and its contents have been freeze dried.

7. The method of claim 4 further comprising the step of increasing the vacuum pressure within the bag after the bag and its contents have been freeze dried.

8. A system for restoring articles that have been damaged by moisture comprising:
a bag having an open portion through which an article can be placed within the bag, said open portion configured to be closed and sealed shut after an article has been placed within the bag;
an air pump designed to engage said bag such that, upon engagement, said pump becomes communicatively attached to said bag, thereby enabling the removal of air from said bag by said pump and the creation of a vacuum; and
a freeze drying apparatus for freeze drying said bag and its contents after a vacuum has been created therein.

9. A system for restoring a damaged article that has been damaged by moisture comprising:
a bag having an open portion through which the article can be placed within the bag, said open portion configured to be closed and sealed shut once the article has been placed in the bag;
an air pump including a hose having an end member designed to engage said bag such that, upon engagement, said pump becomes communicatively attached to said bag, thereby enabling the removal of air from said bag by said pump and the creation of a vacuum, said end member being able to be disengaged from said bag once a vacuum has been created, the disengagement of said end member from said bag creating an opening in said vacuum bag;
a sealing member for sealing said opening in said bag such that a vacuum may be maintained within said bag, thereby creating a vacuum sealed bag; and,
a freeze drying apparatus for freeze drying said vacuum sealed bag and the damaged article therein.

10. The system defined in claim 9, wherein said end member of said hose is a needle which engages said bag by puncturing it, thereby creating said opening.

11. The system defined in claim 10, wherein said sealing member is a piece of tape.

12. The system defined in claim 9, wherein said opening is formed by an air valve portion of said bag, said end member of said hose being a connector designed to engage said air valve portion of said bag.

13. The system defined in claim 12, wherein said sealing member is an air valve opening cap designed to engage said air valve portion of said bag.

14. The system defined in claim 9, wherein said bag is closed and sealed shut by means of a zipper.

15. The system defined in claim 9, wherein said bag is close and sealed shut by means of a corresponding tooth connector

16. The system defined in claim 9, wherein said bag is closed and sealed shut by a role and clamp bar.

17. The system defined in claim 9, wherein said bag is closed and sealed shut by a plastic heat seal.

18. The system defined in claim 9, wherein the damaged article is a book.

19. The system defined in claim 17, wherein press members are attached to said book before it is place into the bag.

20. The system defined in claim 18, wherein said press members are attached to said book with rubberbands.

21. The system defined in claim 18, wherein said press members are attached to said book with clamps.

22. The system defined in claim 18, wherein a breather material is wrapped around said book and said press boards before the book is placed in the bag.

23. The system defined in claim 8, further including a deodorizer compartment that is attached to the bag such that a deodorizing material is drawn from the deodorizer compartment and into the bag when air is removed from the bag by the air pump.
